(19) United States
(12) Patent Application Publication
(10) Pub. No.: US 2019/0049282 A1
(43) Pub. Date: Feb. 14, 2019

(54) SENSOR ARRAY FOR THE POTENTIOMETRIC MEASUREMENT OF A FILL LEVEL IN A CONTAINER

(71) Applicant: BAUMER ELECTRIC AG, Frauenfeld (CH)

(72) Inventors: Daniel Braendle, Frauenfeld (CH); Peter Fend, Lengwil (DE)

(73) Assignee: BAUMER ELECTRIC AG, Frauenfeld (CH)

(21) Appl. No.: 16/100,219

(22) Filed: Aug. 10, 2018

(30) Foreign Application Priority Data
Aug. 14, 2017 (DE) 10 2017 007 946.3

(51) Int. Cl. G01F 23/24; G01F 23/26; G01N 27/30

(52) U.S. Cl. CPC G01F 23/24; G01N 27/301; G01F 23/263

(57) ABSTRACT

A sensor array for a potentiometric measurement of a fill level in a container. The sensor array includes an electro-magnetically shielding array whose potential is dependent on a potential of the container, and an oscillator array which generates an AC voltage. The oscillator array is at least partly arranged in the electro-magnetically shielding array.

### CROSS REFERENCE TO PRIOR APPLICATIONS

Priority is claimed to German Patent Application No. DE 10 2017 007 946.3, filed Aug. 14, 2017. The entire disclosure of said application is incorporated by reference herein.

### FIELD

The present invention relates to a sensor array for the potentiometric measurement of a fill level in a container.

### BACKGROUND

Such sensor arrays have previously been described and are used, for example, to measure container contents in the chemical industry or in the food industry. The ratio of the voltage between an electrode end and the container wall or the return electrode to the voltage applied between the two electrode ends is thereby measured. A prerequisite therefor is least a slight conductivity of the fill material.

If an AC voltage of a sufficiently high frequency is used, the potentiometric measurement method can also be implemented purely physically using the dielectric behavior of the fill material, i.e., with the influence of its electrical capacity.

The disadvantage thereof is, however, that the oscillator array that generates the AC voltage has a certain parasitic capacitance compared to the electrode array and the surroundings, and, on account of asymmetries that are practically always present, couples a common mode component of the alternating voltage into the measurement voltage. With measurements of fill materials that have a low dielectric constant and thus low capacitance, the measurement therefore becomes inaccurate, as the parasitic capacitance of the oscillator array is comparable with the capacitance of the fill material and the error thus increases very sharply, particularly as the fill level drops. Parasitic capacitances such as those that arise, for example, through shielding measures furthermore have a negative impact on the measuring signal. Inductive interference can also be fed into the measuring signal in addition to the parasitic capacitive effects, especially when inductive components are used.

### SUMMARY

An object of the present invention is to provide a solution with which fill materials having a low dielectric constant and which are practically electrically non-conductive, such as pure alcohol or deionized water, can reliably be measured, in particular at low fill levels.

In an embodiment, the present invention provides a sensor array for a potentiometric measurement of a fill level in a container. The sensor array includes an electro-magnetically shielding array whose potential is dependent on a potential of the container, and an oscillator array configured to generate an AC voltage. The oscillator array is at least partly arranged in the electro-magnetically shielding array.

### BRIEF DESCRIPTION OF THE DRAWINGS

The present invention is described in greater detail below on the basis of embodiments and of the drawings in which:

FIG. 1 shows a schematic representation of an embodiment of the present invention; and

FIG. 2 shows a schematic representation of a detail of the embodiment from FIG. 1.

### DETAILED DESCRIPTION

The present invention provides a sensor array for the potentiometric measurement of a fill level in a container, the sensor array comprising an oscillator array for generating AC voltage, whereby the oscillator array is at least partly located in an electro-magnetically shielding array whose potential is dependent on the potential of the container.

The present invention does not generate a voltage difference between the container, which represents the surroundings well based on its size, and the shielding array, so that any parasitic capacitance that may be present cannot become effective.

The present invention can be further improved with the following embodiments, each of which is in itself advantageous and can be combined with each other in any way required, and with the following further developments.

In an embodiment of the present invention, the potential of the shielding array can, for example, track the potential of the container. Such a solution is particularly simple and effective. A tracking device which allows the potential of the shielding array to track the potential of the container may be provided therefor. Tracking here means that the potential of the shielding array is coupled to the potential of the container through a predetermined equation or a predetermined law. There may in particular be a constant difference between the two.

The shielding array may in particular be on the potential of the container if the measuring signal is zero. The measuring signal may, for example, be zero if the oscillator array is not in use, or if the container has reached a certain fill level, such as completely full or completely empty. The measuring signal can of course also be set to zero artificially for assessment purposes.

The oscillator array may comprise an AC voltage source, whereby the AC voltage source is located in the shielding array in order to achieve a good shielding effect.

The oscillator array may further comprise a transformer array, whereby the transformer array is located in the shielding array in order to achieve a good shielding effect.

The oscillator array may in particular be located completely in the shielding array. This reduces coupling to the outside to a minimum.

The entire electronics of the sensor array can, for example, be located in the shielding array in order to achieve the best possible shielding effect.

In an embodiment of the present invention, the oscillator array can, for example, at least partly or, for example, completely, be located outside the electrode. The design of the electrode can thus be particularly small and compact. Other parts of the electronics can also be located outside the electrode. Only one conductor of the oscillator array and/or a feedback conductor for voltage tapping may in particular be located in the electrode.

The shielding array can, for example, be connected to the container via an impedance converter to make the coupling of the container to the shielding array efficient. The impedance converter may be located in the shielding array. The impedance converter may be connected to the container through an input. This may also be a high-resistance input. The impedance converter may also be connected to the shielding array at its output. This may also be a low-resistance output. The impedance converter may be a tracking device for tracking the potential of the shielding array.

For measuring purposes, the sensor array can, for example, have an electrode which is connected to the oscillator array and which can be inserted into the container, the electrode in particular protruding from the shielding array.

One distal end of the electrode can, for example, be connected to an internal ground reference of the impedance converter. If the container is at the same time connected to the input of the impedance converter, a decoupled measuring signal can be picked up at the output, the decoupling measuring signal using the internal ground reference as a base potential.

In order to reduce inductive coupling, a conductor of the oscillator array and/or a feedback conductor for voltage tapping can, for example, be routed in the electrode at a small distance from one wall of the electrode, in particular in contact with the electrode through an insulation element. They can, for example, be routed so that a maximum distance exists between them to prevent crosstalk.

In an embodiment of the present invention, the sensor array can, for example, be designed so that a temperature measurement is also possible at the distal end of the electrode. The sensor array can, for example, comprise at least one first electrically conductive element made of a first material and at least one second electrically conductive element made of a second material therefor, whereby the first electrically conductive element and the second electrically conductive element are located behind each other along a current path, whereby a transition point between the first electrically conductive element and the second electrically conductive element is located at one distal end of the electrode and other transition points are located at least at a temperature reference point located at a distance from the distal end. Further transition points may also be located outside the electrode or at an upper end of the electrode.

Such further transition points can in particular show a constant temperature, for example, in that they are temperature-controlled. It is possible to determine the temperature by measuring the voltage between the two elements.

An amplifying device can, for example, be provided in order to amplify the signal for measuring the temperature.

The first material can, for example, be a constantan, the second material can, for example, be stainless steel.

The sensor array can also have a DC voltage filter to disconnect the DC voltage from the signal for temperature measurement in that only this is, for example, used to determine the temperature.

In an embodiment of the present invention that is particularly compact, the electrode can, for example, comprise the first electrically conductive element. A separate element can thus be dispensed with. The first electrically conductive element can, for example, be formed by the electrode or at least by a part of the electrode.

In order to determine the temperature, the sensor array can, for example, comprise a temperature measuring module with an input, the temperature measuring module being designed to tap the voltage between the first electrically conductive element and the second electrically conductive element, whereby an output signal which is representative of the temperature can be output at an output of the temperature measuring module.

In an embodiment of the present invention, the raw signal can, for example, be routed outwards and an analysis only being performed outside.

Since interference signals are out of phase with the AC voltage of the oscillator array, the sensor array can, for example, have a filter module which filters out of the measuring voltage a component with the same phase as the oscillator array and/or an out-of-phase component of the AC voltage. This makes it possible to analyze only the measuring signal or only the interference signal.

Such a filter module can, for example, be implemented with electrical components or be designed as a software module in which a separation of the in-phase and the out-of-phase components is effected in the software.

The sensor array can, for example, have an evaluation unit for evaluation purposes which evaluates the in-phase component and/or the out-of-phase component.

To supply power to parts located inside the shielding array, the sensor array can, for example, have a transformer which has a primary side located outside the shielding array and a secondary side located inside the shielding array. It can be advantageous if the primary side and the secondary side are metallically isolated from each other. An air gap can, for example, be provided between the primary side and the secondary side. Electromagnetic coupling may be effected via the air gap. A primary coil can, for example, be provided on the primary side, and a secondary coil can, for example, be provided on the secondary side. The primary coil can, for example, have a shield, in particular on the potential of the container. The secondary coil can, for example, have a shield on the potential of the shielding array. Each of the shields can, for example, in particular comprise a thin metal film. Such a power supply can in particular also have a wireless design.

The present invention is described below in greater detail using examples based on advantageous embodiments with reference to the drawings. Advantageous further developments and embodiments shown are independent of each other and can be combined as required, depending on how this is necessary in the application in question.

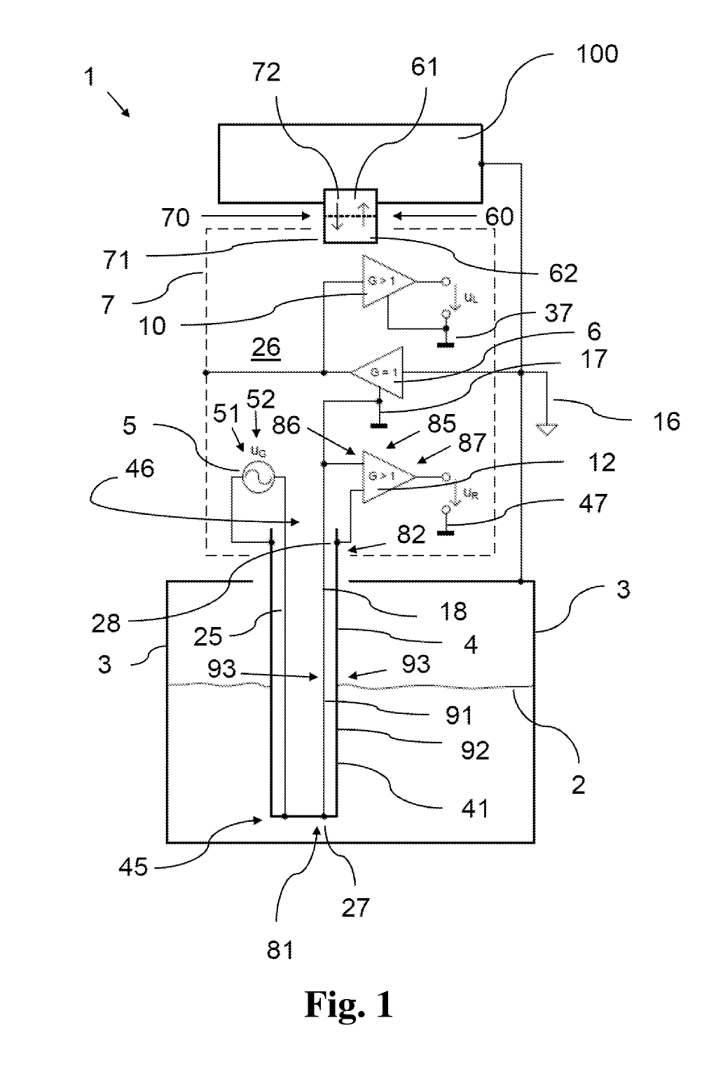

FIG. 1 shows an embodiment of a sensor array 1 for the potentiometric measurement of a fill level 2 in a container 3. An oscillator array 5, which comprises an alternating current generator 51 (which is not shown in greater detail) and a transformer array 52 (which is also not shown in greater detail) generates an AC voltage between an upper or proximal end 46 and a lower or distal end 45 of an electrode 4.

The electrode 4 projects into the container 3 and is covered by the fill material, here, for example, a liquid. The fill level 2 can be determined by comparing the voltage drop between a lower electrode potential 27 and an upper electrode potential 28 with the voltage between the lower electrode potential 27 and the container 3, with the result being evaluated. Since these voltages are small, amplifiers 12 and 10 are used to prepare them for a subsequent evaluation circuit, for example, with a processor with ADC.

One problem here is that the signal is relatively weak and that parasitic capacitances which normally arise against the surroundings affect the signal.

In the shown embodiment, this is prevented or reduced since the oscillator array 5 is located within a shielding array 7 whose potential tracks the potential of the container 3. The potential of the shielding array 7 is thus dependent on the potential of the container 3. While the parasitic capacitances are still present, they do not interfere with the measurement due to the lack of potential difference.

In the shown embodiment, this is solved by connecting the lower electrode potential 27 to the internal ground reference 17 of an impedance converter 6. The input of the impedance converter 6 is connected to the potential 16 of the container 3, whereby the container 3 represents the surroundings well due to its size. It is important to note here that the container 3 is normally very large compared to the sensor array 1.

The shielding array 7 is connected to the output of the impedance converter 6. For a measuring signal of zero, the shielding array 7 is thus on the same potential as the container 3.

The entire sensor array 1 is located within the shielding array 7, i.e., in an enclosed space 26 which is formed by the shielding array 7. An evaluation unit 100 is located outside the shielding array 7 and is connected to the sensor array 1 via an energy transfer array 60 with an energy transmission array 61 and an energy reception array 62 and via a signal transfer array 70 with a signal transmission array 71 and a signal reception array 72. The energy transfer array 60 and the signal transfer array 70 can each be designed so that a transfer takes place without any electrical contact, for example, via light, in particular a laser.

The output of the impedance converter 6 is further connected to the input of a measuring signal amplifier 10 which amplifies and outputs the measuring signal. A ground reference 37, which is the same as the internal ground reference 17, serves as a reference for the measuring signal amplifier 10. The fill level signal UL that is evaluated is the potential between the output of the measuring signal amplifier 10 and the internal ground reference 37 and/or 17.

A feedback conductor 18 for the lower electrode potential 27 is made of a different material from the electrode 4 to also allow for a temperature measurement at the distal end 45 of the electrode 4. The feedback conductor 18 represents a first element 91 made of a first material, such as a constantan, which is connected to a second element 92, namely a part 41 of the wall 44 of the electrode 4, which is made of a second material such as stainless steel. The first element 91 and the second element 92 are connected together at a first transition point 81 located at the distal end 45 of the electrode 4 and are located behind each other along a current path 93. A second transition point 82 is located outside the container 3 at the upper or proximal end 46 of the electrode. There is a largely constant temperature at the proximal end 46, whereas the temperature at the distal end 45 can change depending on the temperature of the fluid or of the fill material. Since the second element 92 is made of a different material from the first element 91, a potential difference is created between the first transition point 81 and the second transition point 82, and this can be used to determine the temperature. Only the DC voltage component of the measuring voltage is here used. A temperature measuring module 85 has a reference voltage amplifier 12 which amplifies the DC voltage measured between the first element 91 and the second element 92, and the DC voltage which is applied at the input 86. The reference voltage UR of the output 87 in relation to a ground reference 47, which again is the same as the internal ground reference 17, is representative of the measured temperature.

Apart from the conductor 25 of the oscillator array 5 and the feedback conductor 18 for voltage tapping, all parts of the electronics, in particular the oscillator array 5, are located outside the electrode 4.

In an embodiment of the present invention which is not shown here, a filter module can, for example, be provided which filters out of the measuring voltage a component with the same phase as the oscillator array and/or an out-of-phase component of the AC voltage. The in-phase component is the useful signal and the out-of-phase component is the interfering component. Such a filter module may be implemented by known electrical components. A filter process can, for example, also be effected via software in an alternate embodiment.

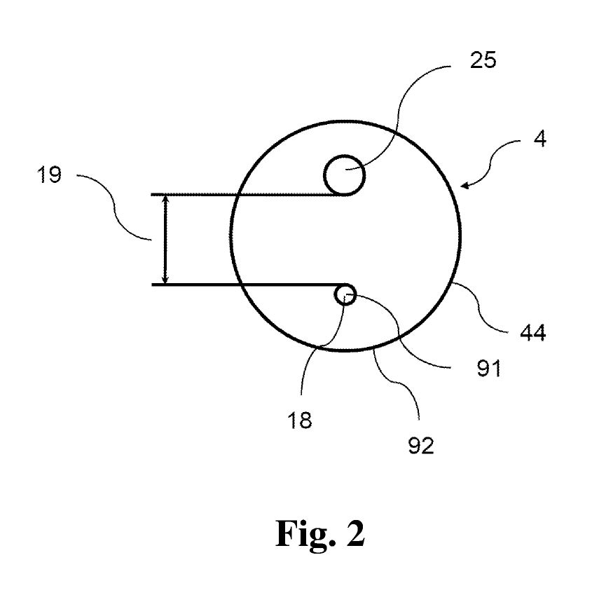

FIG. 2 shows a cross-section of the electrode 4. In order to keep interference signals as small as possible, the feedback conductor 18 for the lower electrode potential 27 and the conductor 25 with which the AC voltage is fed to the lower electrode potential 27 should be located as close as possible to the wall 44 of the electrode 4. The distance 19 between the two should also be as large as possible in order to minimize crosstalk.

The present invention is not limited to embodiments described herein; reference should be had to the appended claims.

What is claimed is:

1. A sensor array for a potentiometric measurement of a fill level in a container, the sensor array comprising:
an electro-magnetically shielding array whose potential is dependent on a potential of the container; and
an oscillator array configured to generate an AC voltage, the oscillator array at least partly being arranged in the electro-magnetically shielding array.

2. The sensor array as recited in claim 1, wherein the potential of the electro-magnetically shielding array is configured to track the potential of the container.

3. The sensor array as recited in claim 2, wherein,
the oscillator array comprises at least one of a transformer array and an AC voltage source, and
at least one of the transformer array and the AC voltage source are arranged in the electro-magnetically shielding array.

4. The sensor array as recited in claim 1, further comprising:
an impedance converter,
wherein,
the electro-magnetically shielding array is connected to the container via the impedance converter.

5. The sensor array as recited in claim 4, further comprising:
an electrode which is connected to the oscillator array and which is configured to be inserted into the container and to protrude from the electro-magnetically shielding array.

6. The sensor array as recited in claim 5, wherein,
the impedance converter comprises an internal ground reference, and
the electrode comprises a distal end which is connected to the internal ground reference of the impedance converter.

7. The sensor array as recited in claim 6, further comprising:
at least one first electrically conductive element made of a first material; and
at least one second electrically conductive element made of a second material,
wherein,
the at least one first electrically conductive element and the at least one second electrically conductive element are arranged behind each other along a current path,
a transition point between the at least one first electrically conductive element and the at least one second electrically conductive element is arranged at the distal end of the electrode, and
other transition points are arranged at least at a temperature reference point which is arranged at a distance from the distal end.

8. The sensor array as recited in claim 7, further comprising:
a temperature measuring module comprising an input and an output, the temperature measuring module being configured to tap a voltage between the at least one first electrically conductive element and the at least one second electrically conductive element,
wherein,
an output signal which is representative of a temperature is configured to be outputted at the output of the temperature measuring module.

9. The sensor array as recited in claim 8, further comprising:
a filter module configured to filter out of a measuring voltage at least one of a component with a same phase as the oscillator array and an out-of-phase component of the AC voltage.

10. The sensor array as recited in claim 1, further comprising:
a transformer comprising a primary side which is arranged outside of the electro-magnetically shielding array and a secondary side which is arranged inside of the electro-magnetically shielding array, the primary side and the secondary side being galvanically isolated from each other.
